(19) United States
(12) Patent Application Publication
(10) Pub. No.: US 2005/0061174 A1
(43) Pub. Date: Mar. 24, 2005

(54) Extension arm for a sheet-processing printing machine

(76) Inventors: Dieterich Dettinger, Heusenstamm (DE); Arno Gartner, Karlstein (DE); Erich Lang, Karlstein (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/415,871

(22) PCT Filed: Oct. 23, 2001
(86) PCT No.: PCT/EP01/12202

(30) Foreign Application Priority Data
Nov. 2, 2000 (DE) 200 18 691.4

(51) Int. Cl. B41F 13/24

(52) U.S. Cl. 101/232

(57) ABSTRACT

A sheet delivery mechanism for a sheet-fed printing machine which is adapted to reduce changes in the position of sheet material in a stack during a stack changeover operation and which facilitates the formation of a stack with properly aligned edges. The sheet-delivery mechanism includes at least one length adjustable edge guide 16 supported between a stack support plate 14 and a cross element 15 which can be detachably connected to the frame of the sheet delivery mechanism.

The invention pertains to a sheet delivery mechanism for a sheet-fed printing machine with a device for changing over from one stack to another according to the preamble of claim 1.

### PRIOR ART

A sheet delivery mechanism of this type is known from DE 195 16 071 A1. This sheet delivery mechanism contains a device for changing over from one stack to another in a sheet-fed printing machine with continuous sheet feeding. In this case, a separating element is used which is composed of a shaft arranged outside the stacking region and one or more wedges, wherein said separating element produces the triangular space required for inserting the stack rake. The separating element lies on the top sheet of the main stack in the region of the front edge. The additional sheets received are simultaneously placed on the auxiliary stack now being formed above the separating element. The sheets accumulated above the separating element are released when the separating element is turned about the shaft and follows the main stack being lowered, wherein the separating element is subsequently pivoted out of the stacking region. This solution can only be used with stack rakes because the wedges must contact the upper edge of the main stack through the intermediate spaces of the stack rake.

A sheet delivery mechanism with a device for changing over from one stack to another in a sheet-fed printing machine with continuous sheet feeding is also known from DE 198 19 491 C1. This device is arranged upstream of a delivery stack (first stacking system) and functions as a switch, wherein said device selectively deposits the sheets on the delivery stack (first stacking system) or on a second stacking system arranged upstream of the first stacking system. During nonstop stack changing mode, for example, the switch is activated in such a way that the sheets can be deposited on the second stacking system. In the meantime, the main stack of the first stacking system, for example, can be lowered and transported away from the sheet delivery mechanism, wherein a new stack board or stack rake is previously inserted, and wherein the sheets that were transported to the second stacking system are now fed to the delivery stack (first stacking system). The stack of the second stacking system can be exchanged in the meantime.

When changing a stack, it is disadvantageous that sheet material stacked properly aligned may change its position in the stack when the stack is changed. The lowering movement and/or the air enclosed between the sheets, particularly, in the upper region of the stack (reduction in static friction) may cause the sheets to change their position in the stack.

### OBJECTIVE OF THE INVENTION

The invention is based on the objective of developing a sheet delivery mechanism of the initially described type which eliminates the aforementioned disadvantages and, in particular, noticeably reduces changes in position in the sheet material when changing from stack to stack, such that the formation of a stack with properly aligned edges can be achieved.

According to the invention, this objective is attained with the characteristics of claim 1. Additional refinements are disclosed in the dependent claims.

A first advantage of the invention is that the sheet delivery mechanism contains an edge guiding device of variable length that is assigned to and located against at least one edge of the sheet material being stacked, for example, the front edge, wherein said edge guiding device is arranged on a vertically movable stack support plate and on a crossarm that preferably is mounted separably on the frame. This edge guiding device guides the sheet material into its predetermined stacking position and, in particular, guides the sheet material when the main stack is lowered. This prevents the material being printed from changing its position in the stack, for example, by shifting, and the proper alignment of the stack edges achieved during the sheet delivery is preserved when (the stack of) sheet material is lowered.

It is also advantageous if the length of the edge guiding device is variable during the vertical upward and downward movement of the stack. Independently of the stack size, this ensures a continuous guidance in the region of one edge, for example, the front edge, of the stacked sheet material when a stack is changed, particularly during the lowering movement.

It is also advantageous if the edge guiding device is arranged a short distance from the edge of the sheet material forming the stack. This makes it possible to prevent friction between one edge of the sheet material and the edge guiding device during the lowering (relative movement) of the stack. This friction could negatively influence the desired position of the sheet material in the stack.

It is equally advantageous if the edge guiding device is preferably arranged on a crossarm, and if this crossarm is separably connected to the frame of the sheet delivery mechanism. The edge guiding device preferably is separably connected to the crossarm. This makes it possible also to realize the stacking operation without an edge guiding device, wherein required free space is not blocked during the stack change.

According to another embodiment, it is advantageous if the separable crossarm can be detached from the frame of the sheet delivery mechanism, preferably in a manual fashion, and separably fixed, for example, on the stack support plate together with the edge guiding device (parking position).

The sheet delivery mechanism according to the invention can be universally used, for example, for the non-stop stack change mode or for the packaging mode (separated partial stacks containing a certain quantity of sheet material).

The invention is not limited to the use of only one edge guiding device. On the contrary, it would also be possible to arrange several edge guiding devices on the given edge(s) of the stack.

### EXAMPLES

The invention is described in greater detail below with reference to an embodiment example. The figures schematically show:

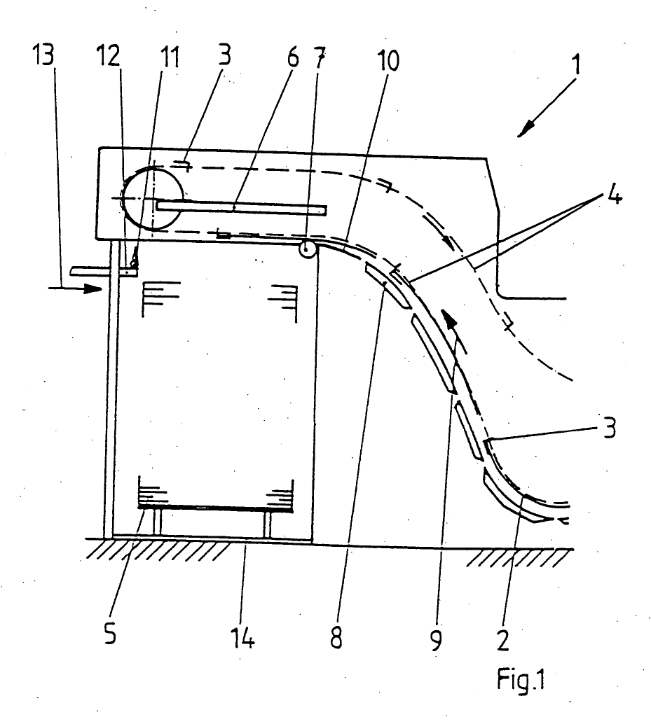

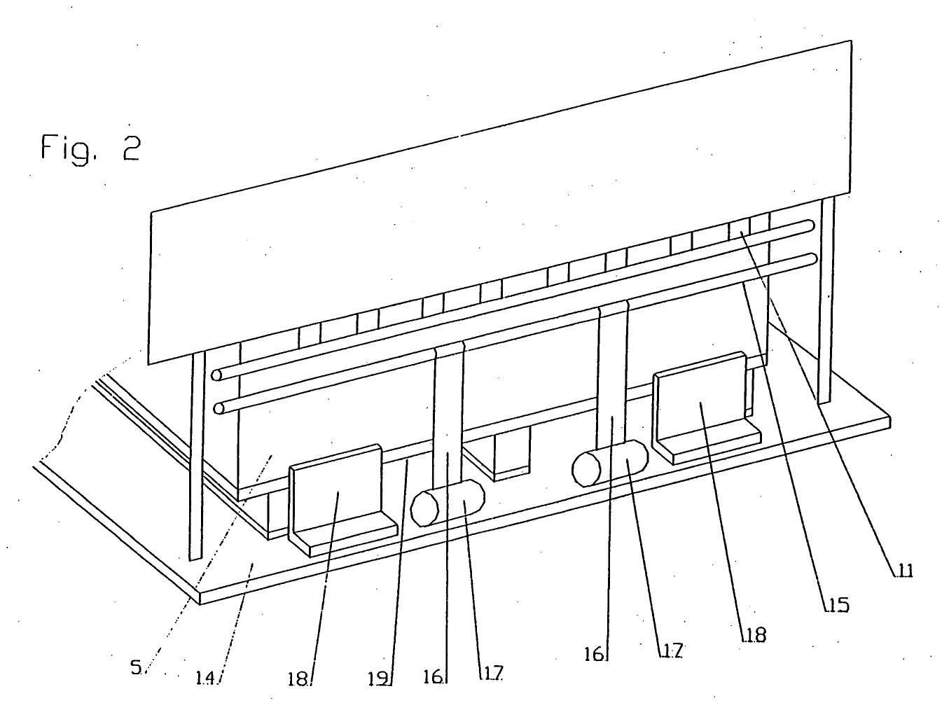

FIG. 1, a sheet delivery mechanism of a sheet-fed printing machine;

FIG. 2, a front view of a sheet delivery mechanism with two edge guiding devices, and

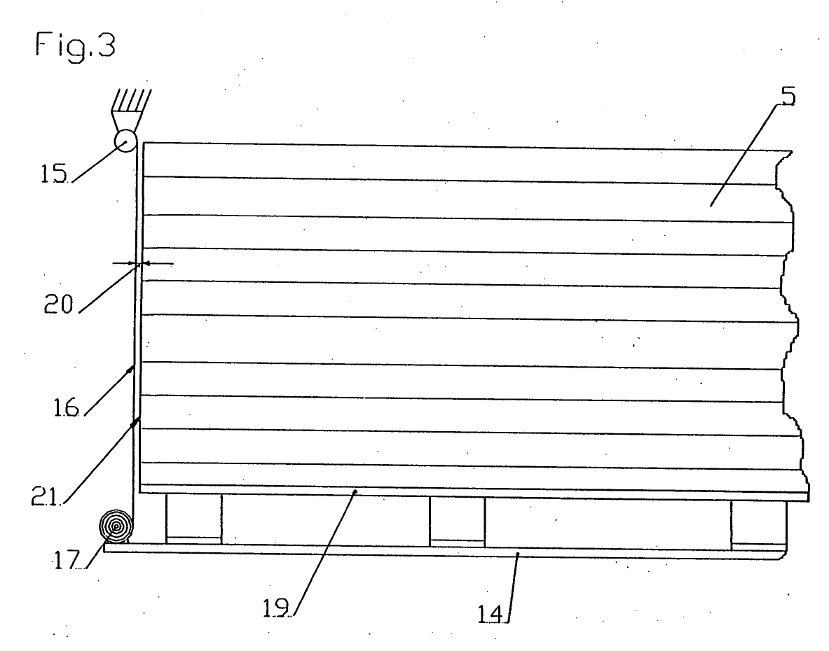

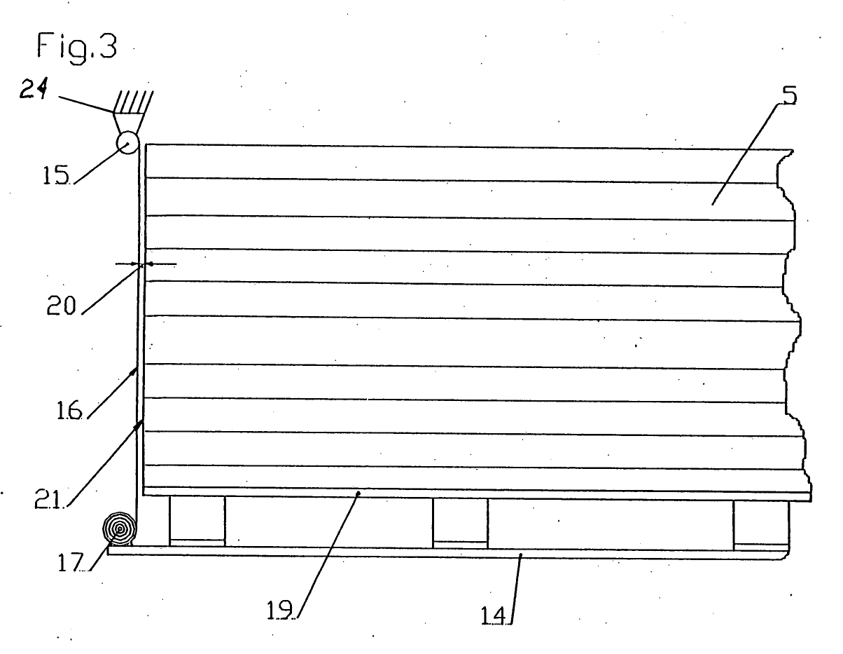

FIG. 3, a side view of the sheet delivery mechanism according to FIG. 2.

A sheet delivery mechanism 1 for the non-stop stack change mode essentially consists of a revolving conveyor system 4 with gripper systems 3 arranged thereon, wherein said gripper systems feed the sheet material 2 arriving from an upstream printing station or converting station to a delivery stack 5. During this process, the sheet material 2 is guided along stationary sheet guiding elements 8 and sheet guiding elements 10 that can be adjusted depending on the format and the print image. The sheet guiding elements 8, 10 preferably can be selectively controlled by means of blasting air and suction air. A pneumatic system 6 that assists in depositing the arriving sheet material 2 on the delivery stack 5 is arranged above the delivery stack 5.

Conventionally, the sheet material 2 arriving in the transport direction 9 is decelerated by a sheet decelerating device 7 and deposited onto the delivery stack 5 such that its front edges contact limit stops 11. Pivoted guides that, for example, consist of angle rails and serve for accommodating an auxiliary stack support 12, e.g., a board or a rake, are arranged parallel to the lateral frames of the sheet delivery mechanism 1. The auxiliary stack support 12 can be horizontally inserted in the inserting direction 13 and-retracted opposite to the inserting direction 13. In order to remove sample sheets or to form an auxiliary stack in the delivery stack 5, the delivery mechanism is provided with known front holding elements for holding up the sheets which extend over the width of the sheets and can be selectively acted upon by blown air or suction air. The front sheet holding elements are arranged such that they protrude into the region of the delivery stack 5 at an acute angle referred to the horizontal line. The front sheet holding elements can be directly moved from a waiting position in the front edge region outside the delivery stack 5 into the stacking region underneath the arriving gripper systems 5 and lowered together with the arriving sheet material 2 in order to form an auxiliary stack.

A crossarm 15 that is preferably mounted separably on the frame of the sheet delivery mechanism on both sides and extends at least over the format width is situated underneath the guides for the auxiliary stack support 12 in the region of the front edge of the delivery stack 5, particularly in the region of the main stack. The delivery stack 5 also contains a stack support plate 14 for receiving a pallet 19 with sheet material 2 stacked on top of one another. The stack support plate 14 is preferably provided with limit stops 18, wherein the pallet 19 is aligned relative to these limits stops.

At least one, preferably two edge guiding devices 16 of variable length are arranged adjacent to one another (aligned) on the stack support plate 14 and on the crossarm 15. Each edge guiding device 16 is assigned to and located against the front edge 21 of the main stack being formed by the sheet material 2 as part of the delivery stack 5, wherein the respective edge guiding devices are arranged parallel to and separated from the front edge of the stack by a predetermined distance 20. The length of each edge guiding device 16 can be varied when the stack support plate 14 is raised or lowered by means of a stack lifting device in order to follow the vertical movement of the stack support plate 14. The change in length of each edge guiding device 16 preferably can be realized synchronously with the vertical movement of the stack support plate 14.

In order to prevent changes in position of the stacked sheet material 2, the edge guiding device 16 is arranged a slight distance 20 from the front edge 21 of the main stack. The distance 20 is chosen such that any friction between the front edge 21 of the sheet material 2 and the edge guiding devices 16 which could impair the position of the sheet material 2 is prevented when the main stack is lowered.

According to one embodiment, the edge guiding device 16 consists of at least one band that can be wound and preferably is under tension. In an alternative embodiment, the edge guiding device 16 contains at least one cable or a corresponding belt that can be wound and is under tension. Each edge guiding device 16 preferably contains a winding device 17 that is arranged on the stack support plate 14. Alternatively, the winding device 17 may also be arranged on the crossarm 15. The winding device 17 serves for winding and unwinding the band material.

In one preferred embodiment, the crossarm 15 can be separated from the frame of the sheet delivery mechanism and deposited on the stack support plate 14 so that it is secured in its position. The band material stored on the winding device 17 is rigidly or separably connected to the crossarm 15 in this embodiment. When depositing the crossarm 15 on the stack support plate 14, the winding device 17 winds the band material, preferably with the aid of a spring. This also applies to the embodiment in which the edge guiding device 16 or the band material can be separated from a crossarm 15 that remains rigidly connected to the frame.

The invention is not limited to only one edge guiding device 16 that is assigned to the front edge 21 of the delivery stack 5. On the contrary, a single or multiple arrangement of (aligned) edge guiding devices 16 can be provided parallel and adjacent to at least one lateral edge and/or the rear edge of the main stack being formed by stacking sheet material 2 on top of one another.

When assigning an edge guiding device 16 to the lateral edges and/or the rear edge of the delivery stack 5, the processing of different sheet formats should be taken into consideration. For this purpose, the crossarms 15 and the edge guiding devices 16 are preferably arranged on the frame of the sheet delivery mechanism or the stack support plate 14 or on the pallet 19 such that they can be adapted to the respective formats.

In principle, the winding device 17 for the edge guiding device 16 may be selectively arranged on the stack support plate 14 (and also on the pallet 19 in the region of the lateral and rear edges) or on the crossarm 15.

In another embodiment, the stacked sheets 2 of the main stack can be pivoted in the transport direction 9 from the essentially horizontal stacking plane, such that their front edges are inclined toward an adjacent vertical edge guiding device 16. This pivoting motion of the main stack may be realized, e.g., by pivoting the stack support plate 14 out of the horizontal plane by means of an actuating device that acts upon the stack lifting device at least while the stack is lowered. For example, the stack support plate 14 can be raised in the vertical direction by a defined amount with tension means of the stack lifting device which only act upon the rear edge of the delivery stack 5. This causes the stack support plate 14 (with the delivery stack 5) to become inclined in the direction of the edge guiding device 16 assigned to the front edge of the delivery stack 5.

In another embodiment, at least one wedge can be placed onto the stack support plate 14 in the region of the rear edge of the delivery stack 5 (before the stack is formed). This wedge engages underneath the pallet 19 and thus inclines the pallet 19 in the transport direction 9. This causes the front edge of the delivery stack 5 to become slightly inclined toward the edge guiding device 16. In another embodiment, a tilting device is arranged on the stack support plate 14 in the region of the rear edge of the delivery stack 5. This tilting device acts upon the pallet 19 in the region of the rear edge by means of an actuating device, for example, a pneumatic or hydraulic actuating device, and causes the delivery stack 5 to become inclined toward the edge guiding device 16. The inclination of the delivery stack 5 must be realized in such a way that the guidance along the respective edges takes place in a largely contactless fashion and that a possible excursion of the edge guiding device 16 from the vertical line due to a contact with the sheet material 2 is prevented.

1-10. (canceled)

11. A sheet delivery mechanism for a sheet-fed printing machine comprising an endless conveyor for transporting printed sheet material to a delivery stack formed by stacking said sheet material, a separating device for separating the delivery stack into an auxiliary stack and a main stack, a stack lifting device including a vertically movable stack support plate for supporting the delivery stack, at least one edge guiding device connected to said support plate and extending in parallel vertical relation adjacent to an edge of the main stack formed by stacking the sheet material, and said edge guide device having a vertical length that varies depending upon the vertical position of said support plate.

12. The sheet delivery mechanism of claim 11 including at least two said edge guiding devices along a common edge of said main stack.

13. The sheet delivery mechanism of claim 11 in which said edge guiding device is connected in vertically extended fashion between said support plate and a frame of said edge guiding device.

14. The sheet delivery mechanism of claim 11 in which said edge guiding device is connected at one end to a crossarm detachably mounted to said frame.

15. The sheet delivery mechanism of claim 11 in which said edge guiding device includes a flexible material vertically positioned adjacent an edge of said main stack and a winding real for winding said flexible material upon itself during raising movement of said support plate.

16. The sheet delivery mechanism of claim 15 in which said flexible material is a band.

17. The sheet deliver system of claim 11 in which said edge guiding device is arranged in parallel adjacent relation to a front edge of the main stack formed by stacking the sheet material.

18. The sheet delivery mechanism of claim 11 in which said edge guiding device is arranged in parallel adjacent relation to a lateral edge of a main stack formed by the sheet material.

19. The sheet delivery mechanism of claim 11 in which said edge guiding device is arranged in parallel adjacent relation to a rear edge of the main stack formed by stacking the sheet material .

20. The sheet delivery mechanism of claim 11 in which said sheet guiding device changes in length as an incident to vertical movement of the support plate.

21. The sheet delivery mechanism of claim 11 in which the vertical length of said edge guiding device is changeable in synchronism with vertical movement of the stack support plate.

22. The sheet delivery mechanism of claim 11 in which said edge guiding device is arranged a predetermined short distance from the edge of the main stack.

23. The sheet delivery mechanism of claim 11 in which said edge guiding device includes a tensioned band material that is wound upon itself to shorten its length upon raising movement of said support plate.

24. The sheet delivery mechanism of claim 11 in which said edge guiding device includes a winding device mounted on the stack for winding the edge guiding device to change its length.

25. The sheet delivery mechanism of claim 24 in which said winding device is removably mounted on said stack support plate.

26. The sheet delivery mechanism of claim 11 in which said main stack of sheet material is supported by said support plate in inclined relation to the horizontal toward an adjacent edge guiding device.
